(19) United States
(12) Patent Application Publication
(10) Pub. No.: US 2012/0091665 A1
(43) Pub. Date: Apr. 19, 2012

(54) Seal Structure

(75) Inventors: Matsuhiro Okuda, Okayama (JP); Tomokazu Sumida, Okayama (JP); Kazuya Yoshijima, Aichi (JP); Takahiro Yamazaki, Aichi (JP); Yoshifumi Yamada, Aichi (JP); Hiroyuki Matsuoka, Aichi (JP); Hirotaka Kurita, Aichi (JP); Susumu Fujita, Tochigi (JP); Yasuhiko Ohashi, Tokyo (JP)

(73) Assignees: Uchiyama Manufacturing Corp., Okayama (JP); Aisin Seiki Kabushiki Kaisha, Aichi (JP); Toyota Jidosha Kabushiki Kaisha, Aichi (JP)

(21) Appl. No.: 13/259,187

(22) PCT Filed: Mar. 18, 2010
(86) PCT No.: PCT/JP2010/054680

§ 371 Date: Dec. 19, 2011

(30) Foreign Application Priority Data
Apr. 7, 2009 (JP) 2009-093386
Apr. 7, 2009 (JP) 2009-093387

(51) Int. Cl. F16J 15/32

(52) U.S. Cl. 277/573

(57) ABSTRACT

A seal structure for sealing a penetrated portion through which a rotary shaft passes between a cover member and the rotary shaft. A seal member is fitted onto the rotary shaft in a manner that the rotary shaft can rotate relative to the seal member, and the elastic buffer member is provided for connection between the seal member and the cover member at the penetrated portion. The seal structure can keep sealing performance by reducing the influence of movements such as vibration and thermal expansion of the cover member and the influence of process tolerance of the cover member on the sealing performance of the seal member attached to the penetrated portion between the cover member and the rotary shaft penetrating the cover member.

### TECHNICAL FIELD

The present invention relates to a seal structure for sealing a penetrated portion through which a rotary shaft passes between a cover member and the rotary shaft, for example, a penetrated portion of a crank shaft on the chain cover for an automobile engine.

### BACKGROUND ART

In an automobile, a crank shaft as rotatably supported in an engine body (crank chamber) is designed to seal between the end of the crank shaft and the engine body in order to prevent leakage of engine oil and the like through an oil seal (refer to Patent Literatures 1 to 3). One end of the crank shaft projects outward through the crank chamber, and is integrally fixed to a crank sprocket in a chain chamber comparted by the chain cover, and further the crank sprocket is wound and wrapped by a chain (timing chain), thus a power transmission system with a cam shaft and the like is constituted. On the other hand, the one end of the crank shaft may pass through the chain cover to project outward and be designed to be connected to another power transmission system through a crank pulley and the like (refer to Patent Literature 4). Lubricant oil is fed in the chain cover of the engine in order to keep the power transmission system smooth by the chain mechanism. And for this purpose, a seal member constituted with an oil seal is fitted in the penetrated portion of the chain cover of the crank shaft in manner that the crank shaft ca rotate relative to the seal member, thereby preventing leakage of lubricant oil out of the chain cover. And such an oil seal has a lip portion constituted by an elastic body made of rubber and the like, which is designed to keep sealing performance by elastically and slidably contacting the circumference of the crank shaft under the fit condition as mentioned above.

### CITATION LIST

### Patent Literature

PTL 1: JP H05-71542 U
PTL 2: JP H05-96537 U
PTL 3: JP H09-300399 A
PTL 4: JP H09-13988 A

### SUMMARY OF INVENTION

### Technical Problem

In recent years, in an aspect of the automobile engine as mentioned above, components of automobile engines have been designed and manufactured using a molded body made from synthetic resin as much as possible in view of weight saving and fuel efficiency. However, when the above-mentioned chain cover is constituted by a molded body made from synthetic resin, the interference of the oil seal to the crank shaft is changed by deformation caused by thermal expansion, stress deformation, vibration, and the like of the chain cover during the operation of the engine, thereby sometimes deteriorating the sealing performance. The design-based interference of the oil seal to the crank shaft cannot be obtained by thermal expansion of the chain cover in case of assembly, and the intended sealing performance may not be obtained. Therefore, the chain cover is usually made of a metal such as aluminum which is rigid and is less expanded with heat and synthetic resin has not been actually used.

The chain cover as disclosed in Patent Literature 4 is made of a metal such as aluminum which is rigid and is low in thermal expansion (such as aluminum cast). A through hole is formed at the penetrated portion of the chain cover through which the crank shaft passes and a seal member constituted by an oil seal is provided for the hole. The construction for integrally securing the chain cover to the front portions of a cylinder block and a cylinder head by fastening is designed such that the oil seal is fitted to the crank shaft, then a bolt is screwed after positioning operation by aligning a positioning pin projecting at the front with a positioning hole provided for the chain cover.

The chain cover inevitably causes process tolerance during production step, so that misalignment is caused by the process tolerance between the oil seal and the crank shaft even when the chain cover is positioned with the positioning pin and the positioning hole. Furthermore, in case of the chain cover covering a wide area, even a little process tolerance greatly affects the degree of the misalignment. The securing as mentioned above is executed with such a large misalignment, the interference of the lip portion to the crank shaft causes deviation in the circumferential direction of the crank shaft, thereby sometimes being a factor of deteriorating the sealing performance. Specifically the chain cover is made of a rigid metal material, so that such misalignment is directly absorbed by the lip portion, thereby sometimes producing deviation of the interference as mentioned above.

Patent Literature 1 discloses a sealing device in which an oil seal (lip member) integrated with a reinforcing ring made from resin is detachably attached to a resin retainer to be attached to an engine body via the reinforcing ring and the oil seal is fitted to the crank shaft. It is disclosed that the retainer and the reinforcing ring are made from resin for saving the weight. However, the size of the retainer is limited so as to be provided around the crank shaft, so that thermal expansion, vibration, and the like of the retainer do not affect the interference of the oil seal. Therefore, Patent Literature 1 does not assume the change in the interference of the oil seal when the retainer is made from resin. Furthermore, it is considered that the process tolerance of the retainer hardly affects the interference of the oil seal.

Patent Literature 2 discloses an oil seal structure in which an oil seal support member is constituted by a connecting member at the rear portion of an engine comprised of a rear end plate or a flywheel housing provided at the rear portion of an engine and an oil seal facing the circumferential surface of the crank shaft is mounted on an inner circumferential wall of the oil seal support member. However, in such an oil seal structure, the rear end plate and the flywheel housing constituting the oil seal support member are not made from resin and the above-mentioned problems do not seem to occur.

It can be expected that the process tolerance of the rear end plate and the flywheel housing constituting the oil seal support member largely affects the interference of the oil seal in such an oil seal structure. This Patent Literature does not refer to any measure for preventing the influence on the interference by the process tolerance and it can be assumed that such problems have not been solved.

Patent Literature 3 discloses an oil seal case which is provided between a crank case and a transmission case, is mounted on the crank shaft projecting from the crank case, and prevents leakage of engine oil in an oil pan to the outside. The oil seal case comprises an elastic member embedded with an annular core member and a synthetic resin member {case body) integrally embedded with the outer circumferential portion of a disk-like projection of the core member together with the elastic member covering the outer circumferential portion. The oil seal case is attached to the crank case or the transmission case with the synthetic resin member in such a manner that the inner circumferential portion of the elastic member slidably contacts the outer circumferential surface of the crank shaft. However, the size of the synthetic resin member as a cover body is limited so as to be provided around the crank shaft, so that thermal expansion, vibration, and the like of the synthetic resin material do not affect the interference of the oil seal. Therefore, Patent Literature 3 does not assume the change in the interference of the oil seal when the cover body is made from resin.

Furthermore, it is considered that the size of the synthetic resin member as a cover body is limited so as to be provided around the crank shaft, so that the process tolerance has little effect on the interference of the oil seal.

The present invention is proposed in view of the above-mentioned problems and has an object to provide a seal structure for keeping sealing performance by reducing the influence of movement such as vibration and thermal expansion of a cover member and the influence of process tolerance of the cover member on the sealing performance of a seal member attached to a penetrated portion between the cover member and the rotary shaft which penetrates the cover member.

### Solution to Problem

A seal structure of the present invention is a seal structure for sealing a penetrated portion through which a rotary shaft passes between a cover member and the rotary shaft, characterized in that a seal member is fitted onto the rotary shaft in a manner that the rotary shaft can rotate relative to the seal member and an elastic buffer member is provided for connection between the seal member and the cover member at the penetrated portion.

In the seal structure of the present invention, the cover member can be constituted by a molded body made from a synthetic resin material. The elastic buffer member and the cover member can be coupled via a connecting ring. A metal ring can be provided between the seal member and the cover member at the penetrated portion in such a manner that the metal ring is concentrically and externally fitted to the seal member. The metal ring can be concentrically and externally fitted to the seal member, and the elastic buffer member is fixed onto an outer circumference of the metal ring. A circumferential groove can be formed on an inner circumference of the connecting ring, and the elastic buffer member can be provided in the circumferential groove in such a manner that the elastic buffer member can elastically and slidably contact the circumferential wall of the circumferential groove in the radial direction. Furthermore, the seal structure of the present invention can be applied to the seal structure in which the cover member covers a portion where lubricant oil is contained and the sealing member is an oil seal.

### Advantageous Effects of Invention

In the seal structure of the present invention, since the seal member is fitted between the cover member and the rotary shaft penetrating the cover member in a manner that the rotary shaft can rotate relative to the seal member, the seal member can seal between the cover member and the rotary shaft, thereby preventing lubricant oil and the like in a space formed with the cover member from leaking out along the circumferential surface of the rotary shaft. Furthermore, since the elastic buffer member is provided for connection between the seal member and the cover member at the penetrated portion, thermal expansion, vibration, and the like of the cover member are absorbed by the elastic buffer member and do not affect the interference of the seal member relative to the rotary shaft, thereby keeping a desirable sealing performance of the seal member.

When the cover member is constituted by a molded body made from synthetic resin, the weight of the apparatus and the like to which the seal structure of the present invention is applied can be reduced.

When the elastic buffer member and the cover member are coupled via the connecting ring in the present invention, the elastic buffer member is coupled to the connecting ring and then the coupled one is attached to a predetermined portion, namely the penetrated portion, of the cover member, thereby facilitating the seal structure.

In the present invention, the metal ring is provided between the seal member and the cover member at the penetrated portion in such a manner that the metal ring is concentrically and externally fitted to the seal member. When the cover member is attached to a predetermined portion, the concentric fitting relation of the metal ring, the seal member and the rotary shaft is automatically determined once the seal member is fitted to the rotary shaft. Therefore, such a fitting relation being set as a reference for attaching the cover member, the cover member can be attached and fixed while keeping a designed interference of the seal member to the rotary shaft even if the cover member has process tolerance, so that the sealing performance of the seal member is not deteriorated by the deviation of the interference.

In the present invention, the metal ring is concentrically and externally fitted to the seal member, and the elastic buffer member is fixed onto the outer circumference of the metal ring. When the cover member is attached to a predetermined portion, the concentric fitting relation of the metal ring, the seal member and the rotary shaft is automatically determined once the seal member is fitted to the rotary shaft. Therefore, if such a fitting relation is set as the attachment reference of the cover member, the cover member can be attached and fixed while keeping a designed interference of the seal member to the rotary shaft even if the cover member has process tolerance. When a reference pin and the like is provided at an appropriate portion of an objective attachment portion on the cover member and the cover member is attached using the reference pin as an attachment reference position, and the interference of the seal member to the rotary shaft causes deviation, which may affect sealing performance in case that the cover member has process tolerance and is expanded or contracted by thermal change in a storage environment. The cover member can be attached with a high degree of accuracy by interposing the metal ring between the elastic buffer member and the seal member. By interaction effect of the elastic buffer member provided between the metal ring and the cover member, even if the cover member is moved by thermal expansion or vibration during operation, such movement is more effectively prevented from being transmitted to the seal member.

In the present invention, according to such an embodiment that the circumferential groove is provided on an inner circumference of the connecting ring and the elastic buffer member is provided in the circumferential groove in such a manner that the elastic buffer member can elastically and slidably contact the circumferential wall of the groove in its radial direction, restraint function against the aging change of the interference due to the vibration can be further remarkably enhanced by interaction effect of the elastic characteristic of the elastic buffer member and the elastic sliding contact by the elastic buffer member in the radial direction in the circumferential groove.

When the seal structure of the present invention is applied to such a seal structure that the cover member covers the portion where lubricant oil is contained and the seal member is an oil seal, adverse effect due to the cover member constituted by a molded body made from synthetic resin will not exerted on the oil seal, the sealing quality of the oil seal will be maintained, and the lubricant oil contained in the portion covered with the cover member will be prevented well from leaking from the penetrated portion.

### BRIEF DESCRIPTION OF DRAWINGS

FIG. 1 is a diagrammatic external front view of an engine applied with a seal structure of the present invention.

FIG. 2 is an enlarged section of fragmentary view as taken along line X-X in FIG. 1.

FIG. 3 is a sectional view of another embodiment of the present invention.

FIG. 4 is a sectional view of another embodiment of the present invention.

FIG. 5 is a sectional view of another embodiment of the present invention. FIG. 6 is a sectional view of another embodiment of the present invention.

FIG. 7 is a sectional view of another embodiment of the present invention.

### DESCRIPTION OF EMBODIMENTS

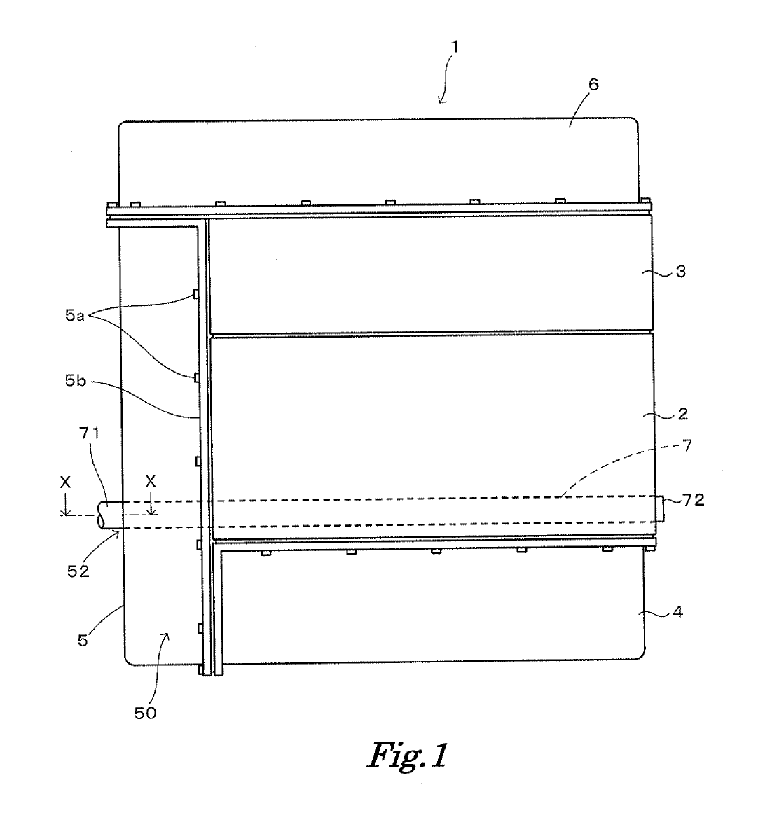

The embodiment of the present invention will be explained hereinafter referring to the drawings. An engine 1 shown in FIG. 1 comprises a cylinder block 2, a cylinder head 3 integrally secured onto an upper surface of the cylinder block 2 by fastening, an oil pan 4 integrally secured onto a lower surface of the cylinder block 2 by fastening, a chain cover (front cover) 5 and a cylinder head cover (rocker cover) 6, in which the chain cover 5 is integrally secured by fastening to the front portions of the cylinder block 2, the cylinder head 3, and the oil pan 4 in a manner that the chain cover 5 strides them in a direction orthogonal to the direction where they are integrally secured, whereas the cylinder head cover 6 is integrally secured by fastening to the cylinder head 3 and the upper end surface of the chain cover 5 together in a manner that the cylinder head cover 6 strides them. In this embodiment, the chain cover 5 as constituted by a molded body made from synthetic resin is given, however, it can be made of a metal material such as aluminum. As for synthetic resin material constituting the chain cover 5, PPA (polyphthalamide), PA (polyamide), and PPS (polyphenylenesulfide) or the like can be employed. A power transmission system can be also constituted by a belt (timing belt) in accordance with a specification of the engine, and in such a system the chain cover 5 is called a belt cover.

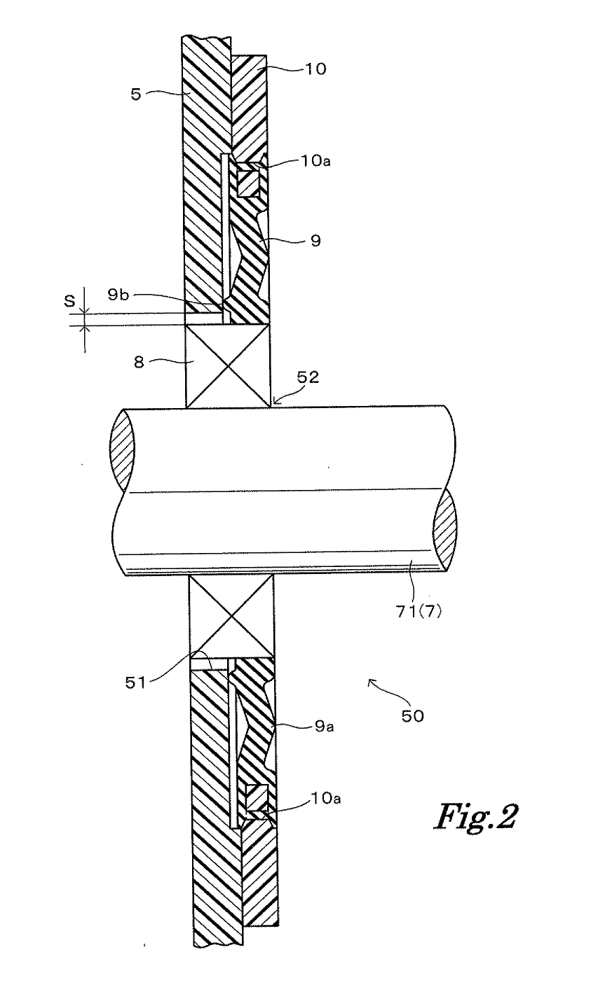

The lower part of the cylinder block 2 is constituted as a crank chamber (not shown) communicating with the upper space of the oil pan 4 and the crank shaft (rotary shaft) 7 is provided horizontally in a rotatable manner in the crank chamber. One end 71 of the crank shaft 7 projects outward in a manner that it passes through the chain cover 5 at the front of the cylinder block 2. The crank shaft 7 is constructed such that a chain pulley (crank sprocket), not shown, is provided in a chain chamber (which contains scattered lubricant oil) 50 comparted by the chain cover 5, and a timing chain (not shown) is wound and wrapped between the chain pulley and a pulley for a cam shaft or the like (not shown) provided in the chain chamber 50, thereby constituting a power transmission system to the cam shaft and the like. The one end 71 of the crank shaft 7 projects from a bore 51 (see FIG. 2) of the chain cover 5 and a pulley (not shown) for constituting a power transmission system to auxiliary machines, not shown, is attached to the end 71. A penetrated portion 52, to be mentioned later, is constituted by the bore 51. The other end 72 of the crank shaft 7 projects from the rear end of the cylinder block 2 and is provided with a flywheel, not shown. The crank shaft 7 is conceptually shown in the figure and it goes without saying that it is connected to each piston via a crank arm and a connecting rod, which are not shown.

The structure of the penetrated portion 52 of the chain cover 5 through which the crank shaft 7 passes is explained. An oil seal (seal ring) 8 is fitted as a seal member onto the circumferential body of the crank shaft 7 at the penetrated portion 52. A conventional and general-use oil seal is used as the oil seal 8 and its structure is not detailed. The oil seal 8 is constituted such that a lip portion constituted by an elastic body made of rubber and the like is integrally fixed to an annular core member, the lip portion includes at least a lip which elastically and slidably contacts the circumferential body of the crank shaft 7, and an oil seal structure is constituted by such an elastic and sliding contact. An annular elastic buffer member 9 constituted by an elastic body made of rubber and the like is integrally fixed onto the outer circumference of the oil seal 8. The elastic buffer member 9 and the oil seal 8 are integrated by cure adhesion of rubber or by means of an adhesive agent.

A connecting ring 10 constituted by a molded body made from synthetic resin is integrally fixed onto the outer circumference of the elastic buffer member 9 and the elastic buffer member 9 and the oil seal 8 are attached to the penetrated portion 52 of the chain cover 5 via the connecting ring 10. The connecting ring 10 is fixed to the inner surface of the chain cover 5 (on the side of the chain chamber 50) by welding or by means of an adhesive agent, thus the elastic buffer member 9 is provided for connection between the oil seal 8 and the chain cover 5. The inner diameter of the bore 51 is larger than the outer diameter of the oil seal 8 and the bore 51 and the oil seal 8 are concentric when the oil seal 8 is attached to the chain cover 5 via the elastic buffer member 9. A buffer space S is thus formed between the oil seal 8 and the bore 51. The elastic buffer member 9 and the connecting ring 10 are integrally fixed, for example, by vulcanization molding of a rubber material to the connecting ring 10 which has been molded with synthetic resin in advance. In order to increase the fixing strength thereof, a through hole 10a is formed at appropriate intervals along the circumferential direction around the inner circumference of the connecting ring 10, a rubber material is proceeded in the through hole 10a when the rubber material is molded, and the proceeded portion has an anchor effect.

The connecting ring 10 is desirably constituted by a molded body of synthetic resin in view of light weight, however, it may be constituted by a metal plate like aluminum.

The elastic buffer member 9 is constituted by an annular molded body made of soft rubber and has an annular bent portion 9a having a section in the form of dogleg between a fixed portion with the oil seal 8 on the side of the inner circumference and a fixed portion with the connecting ring 10 on the side of the outer circumference. An annular bead portion 9b is formed at a portion facing the inner surface of the chain cover 5 and is designed to elastically contact the inner surface of the chain cover 5 when the elastic buffer member 9 is attached to the chain cover 5 via the connecting ring 10. The soft rubber constituting the elastic buffer member 9 includes NBR, ACM, FKM, AEM and the like.

When the chain cover 5 attached with the oil seal 8 via the elastic buffer member 9 and the connecting ring 10 is integrally secured to a predetermined portion of the engine 1 by fastening as shown in FIG. 1, the oil seal 8 is fitted to the crank shaft 7, and then the bolts 5a . . . are screwed. A flange portion 5b is formed around the chain cover 5 and the bolt 5a is screwed for integration via the flange portion 5b. When the chain cover 5 is integrally secured by fastening, the chain chamber 50 is formed between the chain cover 5 and the front portions of the cylinder block 2 and the cylinder head 3 and scattered lubricant oil (not shown) exists therein. Even when the concentric condition of the oil seal 8 and the bore 51 is not kept by the process tolerance of the chain cover 5, thermal expansion thereof, and the like during storage in case of the integrally securing by fastening with the bolts 5a . . . , such misalignment is allowed by the buffer space S and is also absorbed by the interposed elastic buffer member 9. Therefore, deviation of the interference of the oil seal 8 to the crank shaft 7 is not produced and a predetermined sealing performance of the oil seal 8 is safely achieved.

When the engine 1 is operated while the chain cover 5 is thus integrally secured by fastening, the chain cover 5 is vibrated or the chain cover 5 is easily expanded by the heat generated by the engine 1 because it is constituted by a molded body made from synthetic resin, thereby generating relative movement of the chain cover 5 to the crank shaft 7. The chain cover 5 covers a wide area at the front of the cylinder block 2 and the cylinder head 3, so that the thermal expansion degree is remarkably larger than that of the retainer which is also made from resin disclosed in Patent Literature 1. Therefore, the relative moving amount is large and when such a large relative moving amount is directly applied to the oil seal 8, the interference is largely changed. However, the relative movement to the crank shaft 7 is absorbed by the elastic buffer member 9 and is not transmitted to the oil seal 8, so that the interference of the oil seal 8 to the crank shaft 7 is kept in a predetermined condition and the sealing performance is not changed or deteriorated over time. Specifically, the elastic buffer member 9 of the embodiment in the present invention is constituted by a molded body made of soft rubber and the annular bent portion 9a having a dogleg-like section is provided between the fixed portion with the oil seal 8 and the fixed portion with the connecting ring 10. Therefore, the elastic buffer member 9 becomes superior in absorbability of and followability to the relative movement by interaction effect of the elasticity of rubber and flex deformability of the annular bent portion 9a, thereby exerting favorable sealing performance of the oil seal 8.

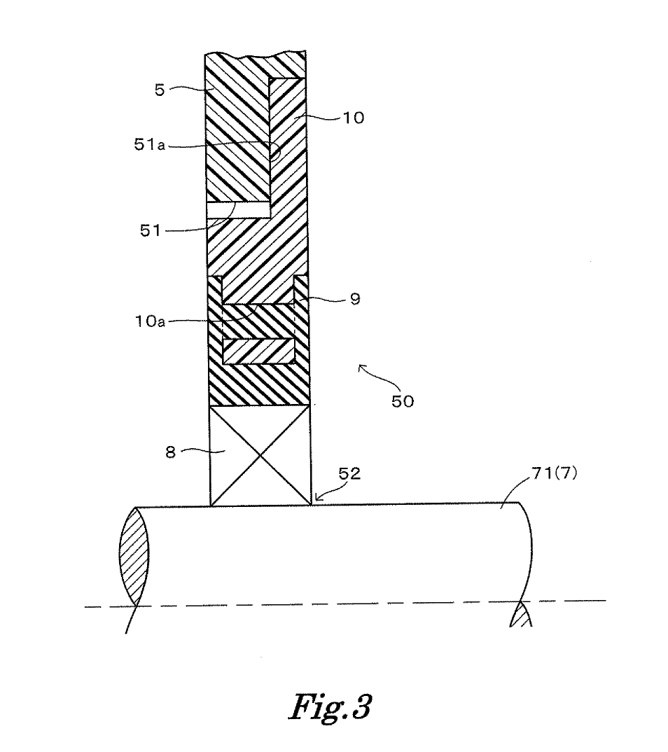

In the embodiment shown in FIG. 3, the elastic buffer member 9 is constituted by a molded body made of hard rubber and is integrally fixed to the entire surface of the outer circumference of the oil seal 8. The connecting ring 10 constituted by a molded body made from synthetic resin is integrally fixed onto the outer circumference of the elastic buffer member 9 including an anchor portion of the through hole 10a as mentioned above.

The connecting ring 10 is further integrally fixed to a stepped surface 51a by welding or by means of an adhesive agent, the stepped surface 51a being formed around the bore 51 of the inner surface of the chain cover 5. The hard rubber has such a hardness that the rubber is not deformed by finger pressure and has a larger elasticity than that of the lip of the oil seal 8. The hard rubber specifically includes NBR, ACM, FKM, H-NBR, AEM and the like. The function effect of the elastic buffer member 9 is the same as mentioned above; however, the embodiment in FIG. 2 or that in FIG. 3 is selectively applied corresponding to the thermal expansion energy and the vibration energy depending on the characteristic of the engine.

The elastic buffer member 9 is made of hard rubber in the embodiment showin in FIG. 3, so that the shape can be well kept and a fitting portion of the oil seal 8 to the crank shaft 7 can be used as a positional reference when the chain cover 5 is attached to a predetermined portion, thereby reducing the change in the interference of the oil seal 8 to the crank shaft 7 caused by the process tolerance of the chain cover 5.

Other structures are the same as those of the embodiment in FIG. 2, common members have the same reference signs and their explanations are omitted.

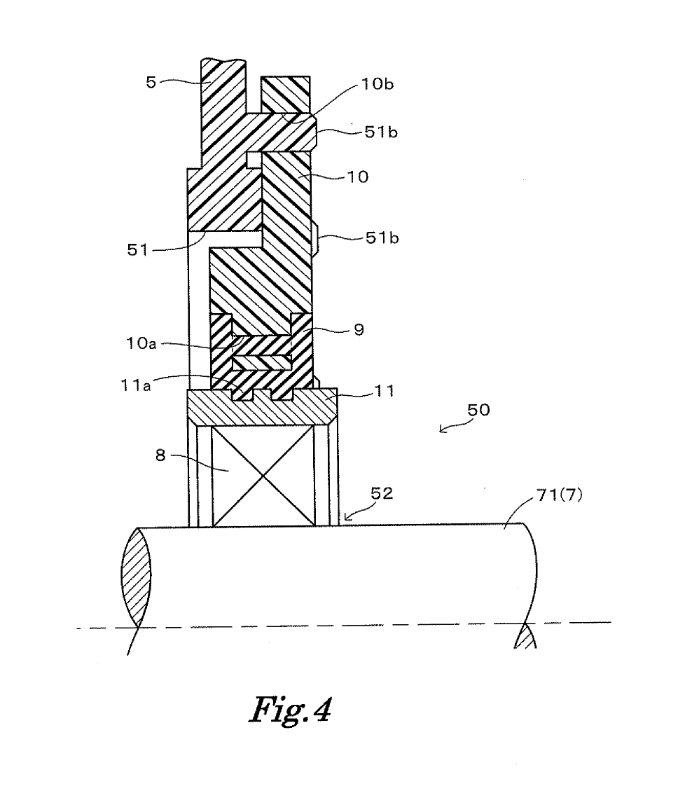

In the embodiment shown in FIG. 4, the metal ring 11 is concentrically and externally fitted to the oil seal 8 and the elastic buffer member 9 is fixed onto the outer circumference of the metal ring 11. Furthermore, the connecting ring 10 constituted by a molded body made from synthetic resin is integrally fixed onto the outer circumference of the elastic buffer member 9 including the anchor portion of the through hole 10a , as mentioned above. The connecting ring 10 is fixed to the chain cover 5 in such a manner that pins 51b . . . and pin holes 10b are rivet welded or welded by contacting surfaces, the pins 51b projecting at some intervals around the bore 51 along the circumferential direction in the inner surface of the chain cover 5 and the pin holes 10b being provided corresponding to the pins 51b on the connecting ring 10. The metal ring 11 is externally fitted to the oil seal 8 by press fit and the metal ring 11 and the elastic buffer member 9 are integrally fixed by vulcanization molding of the rubber constituting the elastic buffer member 9. A concavo-convex portion 11a is formed on the outer circumference of the metal ring 11, and the fixed strength of the metal ring 11 and the elastic buffer member 9 is increased by engaging the rubber material to the concavo-convex portion 11a. The metal material constituting the metal ring 11 is desirably rigid and for example iron and steel, stainless steel such as SUS304, SUS316, SUS430, aluminum alloy and the like are preferably applied.

The metal ring 11 is concentrically and externally fitted to the oil seal 8 in the example in FIG. 4. When the chain cover 5 is attached to a predetermined position as mentioned above, the metal ring 11, the oil seal 8 and the crank shaft 7 are automatically positioned so as to be concentrically fitted when the oil seal 8 is fitted to the crank shaft 7. When the diameter of a bolt hole (not shown) for integrating the chain cover 5 is set so as to be smoothly inserted with the bolt 5a, the bolt 5a is screwed in the condition that such fitting relation is used as an attachment reference of the chain cover 5 even if the chain cover 5 has process tolerance, and the chain cover 5 can be attached and fixed while keeping the interference of the oil seal 8 to the crank shaft 7 as expected when designed. Furthermore, by interaction effect of the elastic buffer member 9 provided between the metal ring 11 and the chain cover 5, even when the chain cover 5 is relatively moved as mentioned above by thermal expansion or vibration during operation of the engine 1, such relative movement is effectively blocked from being transmitted to the oil seal 8. Other structures are the same as those of the embodiments in FIG. 2 and FIG. 3, common members have the same reference signs and their explanations are omitted.

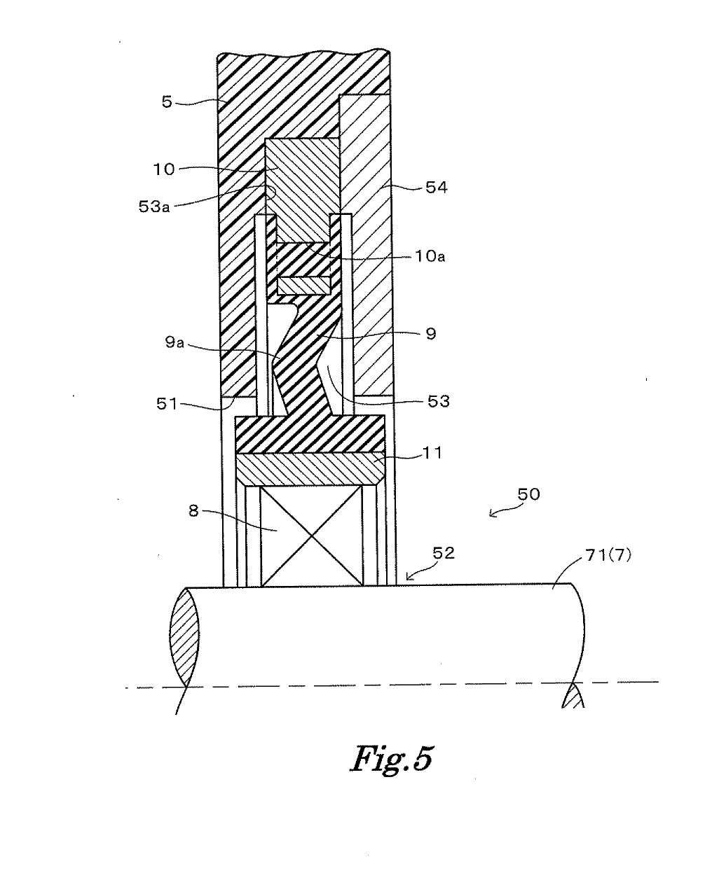

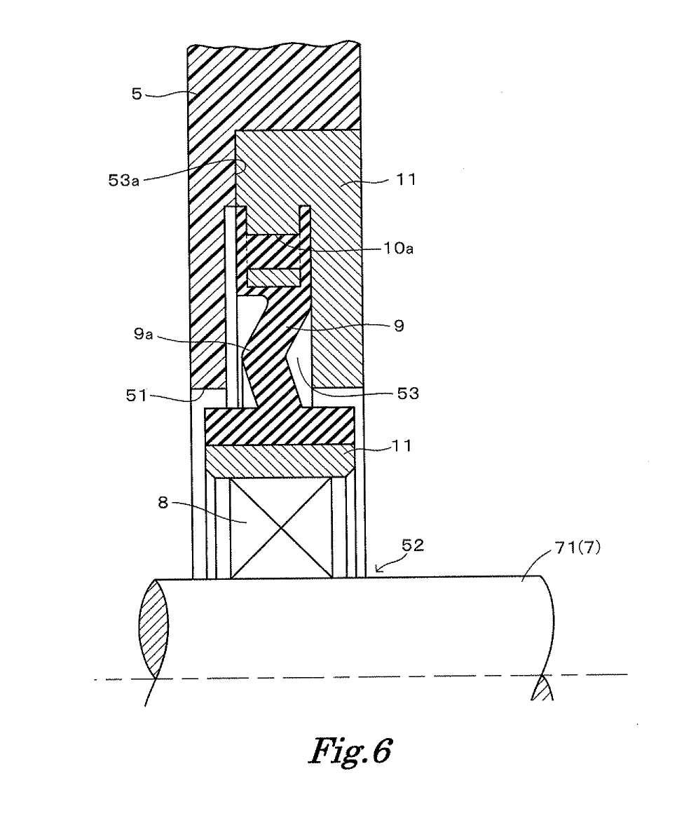

In the embodiment shown in FIG. 5, the metal ring 11 is integrally fitted onto the outer circumference of the oil seal 8 as mentioned above. Furthermore, the annular elastic buffer member 9 is integrally fixed onto the outer circumference of the metal ring 11. The connecting ring 10 constituted by a molded body made of a metal plate or synthetic resin (made of a metal in the figure) is integrally fixed onto the outer circumference of the elastic buffer member 9 including the anchor portion of the through hole 10a as mentioned above. The elastic buffer member 9 is constituted by an annular molded body made of soft rubber and has an annular bent portion 9a having a dogleg-like section between the fixed portion with the metal ring 11 on the inner circumferential side and the fixed portion with the connecting ring 10 on the outer circumferential side. The bore 51 is formed on the chain cover 5 as mentioned above, however, this embodiment includes a circumferential groove 53 hollowed into the radially outward direction at the open end of the bore 51. The inner surface side of the chain cover 5 around the bore 51 is constituted by a divided annular piece 54 and the circumferential groove 53 is formed by integrating the divided annular piece 54 with the chain cover 5 by welding or by adhering with an adhesive agent. The connecting ring 10 is integrally fitted by welding or by means of an adhesive agent to a stepped portion 53a which becomes the bottom of the circumferential groove 53 and which is formed around the bore 51, and the divided annular piece 54 is integrated by welding or by means of an adhesive agent to the inside of the chain cover 5 so as to sandwich the connecting ring 10, thereby constituting the circumferential groove 53. As a result, the seal structure shown in the figure is constituted.

Also in the embodiment in FIG. 5, the metal ring 11 and the elastic buffer member 9 are interposed between the chain cover 5 and the oil seal 8, so that the effect caused by the process tolerance of the chain cover 5 can be reduced as mentioned above and aging change in sealing performance of the oil seal 8 caused by vibration can be controlled. Furthermore, the elastic buffer member 9 is made of soft rubber and has the annular bent portion 9a, so that the elastic buffer member 9 is flexible in elastic deformability in the radial direction and becomes superior in absorbing vibration. Therefore, the interference of the oil seal 8 is kept in an expected condition and the aging change in the sealing performance is effectively inhibited.

Other structures are same as those of the embodiment shown in FIG. 2, common members have the same reference signs and their explanations are omitted.

In the embodiment shown in FIG. 6, although the elastic buffer member 9 has the same shape as that in the embodiment in FIG. 5, they are different in that the connecting ring 10 is formed so as to include the divided annular piece 54 shown in FIG. 5, thereby substantially having the circumferential groove 53 hollowed into the radially outward direction at the open end of the bore 51. Namely in this embodiment, the connecting ring 10 integrated with the oil seal 8, the metal ring 11 and the elastic buffer member 9, which are integrated in the same fixing relation as mentioned above, is integrally fixed by welding or by means of an adhesive agent to the stepped portion 53a formed around the bore 51 provided inside of the chain cover 5, thereby constituting the seal structure as shown in the figure. Therefore, the same function effect like the embodiment in FIG. 5 can be obtained in this embodiment.

Other structures are same as those of the embodiment shown in FIG. 5, common members have the same reference signs and their explanations are omitted.

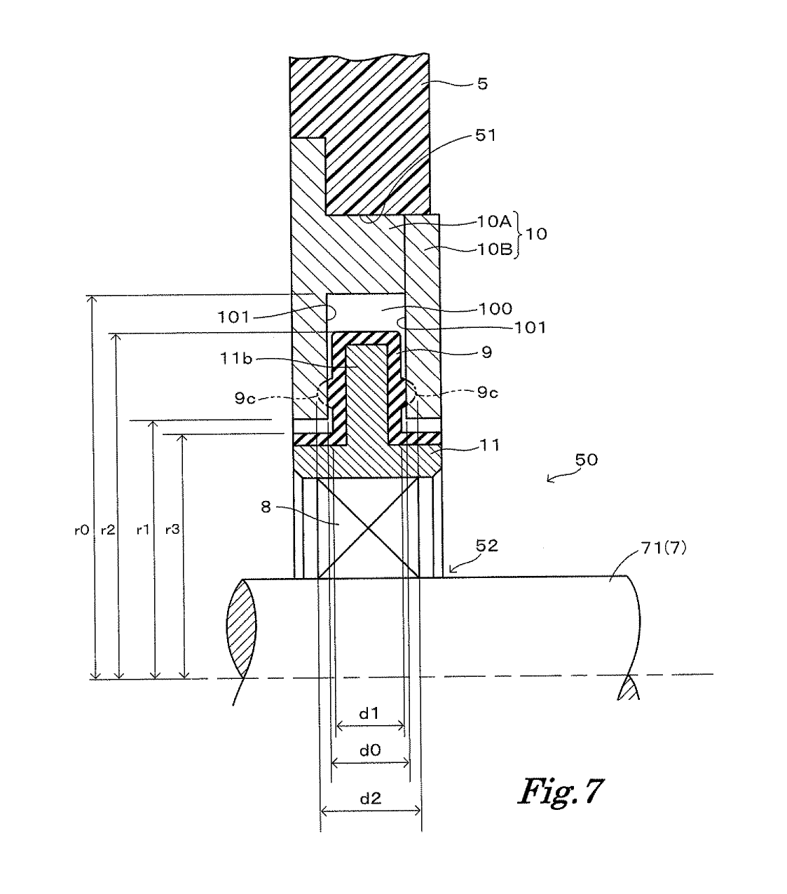

In the embodiment shown in FIG. 7, a circumferential groove 100 hollowed into the radially outward direction is formed on the inner circumference of the connecting ring 10 and the elastic buffer member 9 is included in the circumferential groove 100 in an elastically slidable manner in the radial direction along circumferential walls 101, 101. Specifically, the connecting ring 10 comprises two combination members 10A, 10B; one member 10A is constituted by a specifically formed annular member having a stepped sectional shape, and the other member 10B is constituted by a plane circular member having a rectangular sectional shape. When both members 10A, 10B are combined, an opening of the stepped portion on the side of the chain chamber 50 is defined by the other combination member 10B, thereby constituting the circumferential groove 100 as shown in the figure. The metal ring 11 has an outward flange portion 11b projecting in the radial direction at the center of the outer circumference, and the elastic buffer member 9 is made of rubber material as mentioned above and is formed so as to be integrally fixed to and cover the outer circumference of the metal ring 11 and the outward flange portion 11b along their shape. Chevron-like annular bead portions 9c, 9c projecting in parallel with the axial direction of the crank shaft 7 are symmetrically formed at both sides (axial surface) of the elastic buffer member 9 covering the outer flange portion 11b.

The elastic buffer member 9 is integrally fixed to the metal ring 11 by vulcanization molding of a rubber material in such a manner that the width d1 of the outer surface covering the both sides of the outward flange portion 11b is designed to be smaller than the groove width d0 of the circumferential groove 100 and the width d2 between the tops of the annular beads 9c, 9c is designed to be larger than the groove width d0 of the circumferential groove 100. Furthermore, the size relation of the inner diameter (radius) r0 of the bottom of the circumferential groove 100 of the connecting ring 10, the inner diameter (radius) r1 of the inner circumference of the connecting ring 10, the outer diameter (radius) r2 of a portion of the elastic buffer member 9 covering the outer circumference of the outward flange portion 11b, and the outer diameter (radius) r3 of a portion of the elastic buffer member 9 covering the outer circumference of the metal ring 11 is r0>r2>r1>r3.

The oil seal 8, the metal ring 11 constructed as mentioned above, the elastic buffer member 9, the connecting ring 10, and the chain cover 5 are assembled as follows. First, the metal ring 11 and the elastic buffer member 9 are integrated by vulcanization molding and then the metal ring 11 is concentrically and externally fitted to the oil seal 8, as mentioned above. Next, a portion covering the outward flange portion 11b of the elastic buffer member 9 is positioned to the stepped portion of one combination member 10A, the other combination member 10B is combined with the combination member 10A, the combined surfaces are fixed by welding or by means of an adhesive agent, and the connecting ring 10 having the circumferential groove 100 is constituted. The width d2 between the tops of the annular bead portions 9c, 9c is designed to be larger than the groove width d0 of the circumferential groove 100 when the connecting ring 10 is constituted, so that the annular bead portions 9c, 9c are pressed from the condition shown with two-dot chain lines into the condition shown with solid lines and the metal ring 11 and the elastic buffer member 9 are elastically held while allowing relatively elastic and slidable contact to the connecting ring 10 in the radial direction. By the above-mentioned relation of r0>r2>r1>r3, the metal ring 11 and the elastic buffer member 9 are allowed to contact the metal ring 10 in the radial direction relatively in elastic and slidable manner. Then, the annular bead portions 9c, 9c are elastically compressed between both circumferential walls 101, 101 of the circumferential groove 100, thereby constituting the seal structure thereof. Furthermore, the connecting ring 10 is fitted in the bore 51 of the chain cover 5 under such conditions and the fit-in portion is welded or bonded with an adhesive agent, thereby integrating the connecting ring 10 and the chain cover 5. The shape of the fitting portion of the connecting ring 10 and the chain cover 5 is preferable in the form of a faucet in order to obtain enough hardness as shown in the figure, however, it may be simply a concentric fit-in of the annular portions.

When the chain cover 5 assembled with the oil seal 8, the metal ring 11, the elastic buffer member 9, and the connecting ring 10 is integrally secured to a predetermined position of the engine 1 by fastening as shown in FIG. 1, first the oil seal 8 is fitted to the crank shaft 7. In this case, the metal ring 11 is concentrically and externally fitted to the oil seal 8, so that the concentrically integrated relation of the crank shaft 7, the oil seal 8 and the metal ring 11 is established. Thereafter, the chain cover 5 is integrally secured by fastening to a predetermined portion with the bolts 5a . . . ; however, if the chain cover 5 has process tolerance, the center of the bore 51 and the axial center of the crank shaft 7 are misaligned. The metal ring 11 and the elastic buffer member 9 are elastically held to the connecting ring 10 so as to be relatively, elastically and slidably contacted in the radial direction, so that such misalignment is absorbed by the relative, elastic and slidable contact.

When the oil seal 8 is fitted to the crank shaft 7, the integrated concentric relation of the metal ring 11, the oil seal 8 and the crank shaft 7 is not changed and the interference of the lip portion of the oil seal 8 to the crank shaft 7 is kept constant along the circumferential direction. Even when the chain cover 5 is vibrated by operating the engine 1, the vibration is absorbed by the relative, elastic and slidable contact, whereby the concentric integrated relation of the metal ring 11, the oil seal 8 and the crank shaft 7 is not changed. Therefore, when the chain cover 5 has process tolerance or the chain cover 5 is vibrated, the interference is kept at a desirable constant condition without causing deviation by the tolerance or vibration. Scattered lubricant oil exists in the chain chamber 50 formed by integrally securing the chain cover 5 by fastening; however, an intended sealing performance is kept by the oil seal 8 fit with constant interference and the lubricant oil is surely prevented from leaking from the penetrated portion 52.

Other structures are same as those of the above-mentioned embodiments, common members have the same reference signs and their explanations are also omitted.

The above-mentioned embodiments show a seal structure for sealing the penetrated portion 52 of the chain cover 5, through which the crank shaft 7 passes, of the engine 1; however, the present invention is not limited to such a structure. When the present invention is applied to the penetrated portion of a cover member, through which a rotary shaft passes, constituted by a molded body made from synthetic resin, and specifically the penetrated portion in which the cover member is easily expanded by heat at high temperature or is easily vibrated, the same effects as mentioned above can be achieved. The shapes of the elastic buffer member 9, the connecting ring 10 and the metal ring 11, and the integrated structure thereof are not limited to those shown in the figures.

### REFERENCE SIGNS LIST

1 engine
5 chain cover (cover member)
50 chain chamber (where lubricant oil is supplied)
52 penetrated portion
7 crank shaft (rotary shaft)
8 oil seal (seal member)
9 elastic buffer member
10 connecting ring
11 metal ring

1. A seal structure for sealing a penetrated portion through which a rotary shaft passes between a cover member and the rotary shaft, comprising:
a seal member is fitted onto said rotary shaft in a manner that said rotary shaft can rotate relative to said seal member; and
an elastic buffer member is provided for connection between said seal member and said cover member at said penetrating portion, said elastic buffer member being provided outward from said seal member.

2. The seal structure as set forth in claim 1, wherein said cover member is constituted by a molded body made from a synthetic resin material.

3. The seal structure as set forth in claim 1, wherein said elastic buffer member and said cover member are coupled via a connecting ring.

4. The seal structure as se forth in claim 1, wherein a metal ring is provided between said seal member and said cover member at said penetrated portion in such a manner that said metal ring is concentrically and externally fitted to said seal member.

5. The seal structure as se forth in claim 1, wherein a metal ring is concentrically and externally fitted to said seal member, and wherein said elastic buffer member is fixed onto an outer circumference of said metal ring.

6. The seal structure as set forth in claim 3, wherein a circumferential groove is formed on an inner circumference of said connecting ring, and wherein said elastic buffer member is provided in said circumferential groove in such a manner that said elastic buffer member can elastically and slidably contact said circumferential wall of the circumferential groove in the radial direction.

7. The seal structure as set forth in claim 1, wherein said cover member covers a portion where lubricant oil is contained, and wherein said sealing member is an oil seal.
